(19) United States
(12) Patent Application Publication
(10) Pub. No.: US 2013/0005163 A1
(43) Pub. Date: Jan. 3, 2013

(54) ELECTRICAL CONTACT ARRANGEMENT

(75) Inventors: Dieter Holste, Detmold (DE); Ulrich Rosemeyer, Schieder Schwalenberg (DE)

(73) Assignee: Phoenix Contact GMBH & Co., KG, Blomberg (DE)

(21) Appl. No.: 13/579,687

(22) PCT Filed: Mar. 3, 2011
(86) PCT No.: PCT/EP2011/053193

§ 371 Date: Sep. 20, 2012

(30) Foreign Application Priority Data
Mar. 4, 2010 (DE) 10 2010 010 331.4

(51) Int. Cl. H01R 12/00

(52) U.S. Cl. 439/83

(57) ABSTRACT

The invention relates to an electrical contact arrangement of a spring contact element (10) on a printed circuit board (12) with a soldering area (16) arranged on a surface of the printed circuit board (12) and a planar contact area (18) arranged on the soldering area (16), wherein the spring contact element (10) can be arranged on the contact area (18).

### BACKGROUND

The innovation applies to an electrical contact arrangement for a spring contact element on a printed circuit board.

A soldering surface in form of a copper surface is generally attached on printed circuit boards in the conductive pattern of the printed circuit board for the purpose of contacting for the direct contacting of spring contact elements on printed circuit boards. The surface of the copper surface is conductive and can be soldered. However, with this type of contacting, it is usually only possible to arrange the spring contact elements on the front side and/or the side of the printed circuit board that points up. With this type of manufacturing, the surface is exposed to a high level of wear due to the contacting and forces in the contacting state, e.g. due to vibration. In addition, the arrangement of the spring contact element requires a great amount of space to establish contacting.

The purpose of this innovation is therefore to provide an electrical contact arrangement for a spring contact element on a printed circuit board, which is marked by an arrangement that has less wear and a reduced space requirement. The task is solved according to the innovation with the characteristics of claim 1. Advantageous designs of the innovation are specified in the sub-claims.

The electrical contact arrangement of a spring contact element on a printed circuit board according to the innovation has a soldering area that is arranged on a surface of the printed circuit board and a level contact surface that is arranged on the soldering surface, whereby the spring contact element can be arranged on the contact surface.

The electrical contact arrangement according to the innovation is marked in that a soldering surface is arranged on at least a partial area of the surface of the printed circuit board and a level contact surface is attached onto this soldering surface. Level design means that the contact surface is designed in form of a plate, for example. A spring contact element can then in turn be arranged on this contact surface. The soldering surface must preferably be designed so that soldering paste pressure can be evenly distributed or optionally partially when a soldering agent is applied to the soldering surface, where by the soldering surface may cover the entire area or a partial area of the surface of the contact surface. Preferably, the soldering surface is provided at four edge cover areas of the contact surface. The contact surface can be secured on the printed circuit board, for example, with the soldering surface and the soldering agent that is applied to the soldering surface. The level contact surface is self has an electrically conductive design and serves as a mechanical storage to secure the spring contact element on the printed circuit board on one hand and to produce an electrical contacting of the spring contact element with the printed circuit board on the other. The provision of the soldering surface and the level design of the contact surface on it, it makes it possible to arrange the spring contact element on the bottom side of the printed circuit board so that it is possible, for example, to provide a connection between the shield and the spring contact element and/or design the spring contact element as a shield connection, which should preferably establish a contact below the printed circuit board for space saving purposes. It is thereby possible with the electrical contact arrangement according to provide contacting with the least possible amount of wear and as space-saving as possible, especially for the establishments of contacts in areas where the installation space is scarce. The level contact surface is also marked by space-saving arrangeability. In addition, the contact arrangement according to the innovation provides the option for repairs on the printed circuit board that may become necessary due to wear, which was not possible with known electrical contact arrangements until now.

According to an advantageous design of the innovation, the level contact surface is a sheet metal element. The sheet metal element is marked by the ability to save significant space in its arrangement, whereby the sheet metal element can be designed as large and thick as desired. The sheet metal element is preferably made of a bronze material, preferably CuSn6 and can also be designed with a conductive surface that protects against corrosion, preferably made of tin (Sn), silver (Ag) and/or gold (Au). This provides an especially good conductivity of the contact surface. The level contact surface designed as a sheet metal element enables the prevention of the wear of the printed circuit board in the contract area. It usually has a base coating. The base coating generally consists of any thickness of copper, which is directly applied to and bonded with the printed circuit board. One or more surfaces may be placed onto this base coating. The provision of a sheet metal element provides for the availability of an especially cost-efficient contact surface. Furthermore, it is preferably provided that the spring contact element can be slid parallel to the longitudinal surface of the printed circuit board onto the level contact surface. This provides for an especially simple and secure attachment of the spring contact element on the printed circuit board, whereby it is preferred the establishment of a contact is thereby possible in a very limited installation space. The manageability of the electrical contact arrangement can thereby be significantly improved compared to known electrical contact arrangements.

Preferably, a soldering paste is applied to the surface of the printed circuit board to create a mat-type soldering paste surface. Mat-type hereby has the preferred meaning that the soldering agent that is designed in form of a soldering paste is applied to the soldering surface so that the soldering surface is wetted with the soldering paste. The soldering paste can thereby be applied according to the dimensions of the contact surface on the printed surface board, but the area for the soldering paste can also be smaller or larger than the dimensions of the contact surface. For example, the soldering paste may be applied by pressing it on. During the application of the soldering paste it is possible to provide an overall application or provide several separate areas. The application of the soldering paste preferably results in a mat-type soldering paste area, which provides for an especially good attachment of the level contact surface on the soldering surface. When using a soldering paste as a soldering agent, it is preferred to use Reflow soldering to secure the contact surfaces on the printed surface board. For this purpose, soldering paste is first applied to the soldering surface of the printed circuit board. Next, the level contact surface will be arranged on the soldering paste and/or soldering surface. The use of soldering paste has the advantage that it has bonding effect without the necessity of additional adhesives and the level contact surface can thereby be applied directly on the soldering paste and/or soldering surface. The addition of heat will melt the applied soldering paste, whereby the level contact surface can automatically center itself on the soldering surface as a result of the surface tension due to the melting of the soldering paste and/or soldering agent. The use of a soldering paste provides for a large-area soldering process to establish a simple weld.

It is furthermore deemed preferable that the printed circuit board has a through-flow bore in the area of the soldering surface, whereby the through-flow bore must be designed as a ventilation bore or whereby the through-flow bore is provided to establish through-contacting. If the through-flow bore is designed as ventilation bore, it is possible that air may escape when soldering the soldering surface so that the heat that is generated during the soldering process can be discharged. This can prevent the development of air bubbles and/or shrinkages between the soldering surface and level contact surface, which may increase the stability of the connection of the soldering surface with the contact surface, especially against shearing forces and also shearing and pressure stress. Furthermore, additional soldering agent can be supplied through the ventilation bore, which means preferably an additional soldering process on the side of the printed circuit board across from the contact surface as needed to be able increase the stability of the solder joint between the contact surface and soldering surface. When the through-flow bore is designed as a through-flow contacting, the soldering agent applied on the soldering surface can be anchored in the through-flow bore, which results in that the stability of the joint of the soldering agent with the soldering surface and/or printed circuit board can be improved, especially against shearing forces. When soldering agent is additionally supplied to the soldering agent that is already present on the soldering surface through the through-flow bore that is designed as a through-flow contact, the stability of the contact surface can also be increased on the soldering surface against shearing forces. The provision of a through-flow bore designed as through-flow contacting to supply soldering agent enables a reflow and subsequent wave soldering process.

Furthermore, it is preferred to provide that the contact surface has a bevel and/or chamber-bevel in at least one of its edge areas. The provision of a bevel and/or chamber-bevel can make the deflection of the spring contact element possible when the spring contact element is secured on the contact surface, which then makes the installation simpler and reduce stress on materials. For example, when a bevel is provided on the contact surface, the contact surface may be designed in form of a straight shaped contact surface and/or a straight shaped sheet metal element, whereby the bevel may be designed on one of the edges of the straight contact surface and/or straight sheet metal element. The chamber-bevel may be provided by angling the contact surface and/or the sheet metal element or by modifying the thickness of the contact surface and/or sheet metal element. The provision of a bevel and/or chamber-bevel prevents damage to the spring contact element, especially during the attachment of the spring contact element on the contact surface. Further, the provision of a bevel and/or chamber-bevel makes it possible that the spring contact element can be inserted in an angle in horizontal direction and also vertical direction to the contact surface and the inserting of the spring contact element with the contact surface is thereby simplified, which in turn simplifies the manageability when securing the spring contact element on the contact surface and/or printed circuit board. The bevel and/or chamber bevel are preferably provided on the edge of the contact area, which is provided in insertion direction and/or attachment direction of the spring contact element on the contact surface in front and/or as the first.

The innovation is explained in more detail below referencing the attached drawing based on a preferred design.

The following is shown:

### BRIEF DESCRIPTION OF THE DRAWINGS

FIG. 1 a schematic illustration of an electrical contact arrangement according to the innovation;

FIG. 2 a schematic illustration of a printed circuit board with the soldering surface that is arranged on it according to the innovation in a top view on the bottom of the printed circuit board;

FIG. 3 a schematic illustration of the printed circuit board shown in FIG. 2 in a top view of the top of the printed circuit board; and

FIG. 4 a schematic illustration of the contact surface according to the innovation.

### DETAILED DESCRIPTION

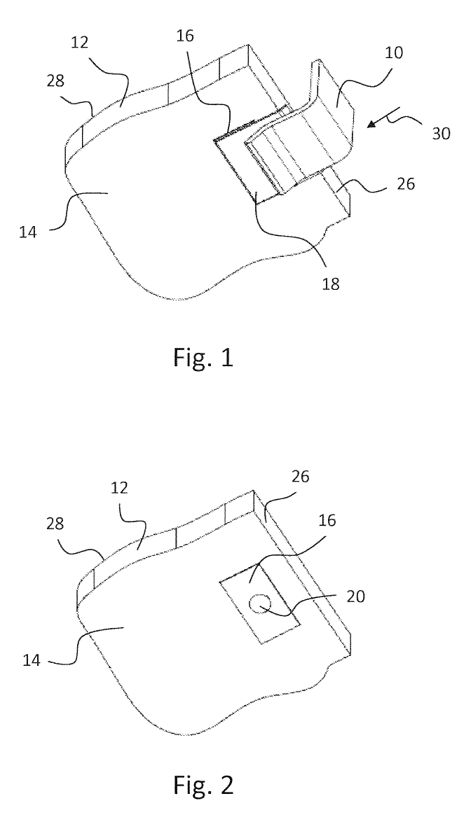

FIG. 1 shows a schematic illustration of an electrical contact arrangement of a spring contact element 10 on a printed circuit board 12 according to the innovation, whereby a top view of the bottom 14 of the printed circuit board 12 is hereby shown. A soldering surface 16 onto which a mat-shaped soldering paste surface can be applied is provided on the surface of the bottom 14 of the printed circuit board 12. A level contact surface 18 in form of a sheet metal element is arranged on the soldering surface 16, on which the spring contact element 10 can be attached to establish a contact between the spring contact element 10 and the printed circuit board 12. The spring contact element 10 can thereby serve as a shielding connection. The spring contact element 10 is preferably secured on the contact surface 18 by sliding the spring contact element 10 onto the contact 18 using the side 26 of the printed circuit board 12, whereby a preferred direction to slide the spring contact element 10 on is marked with the arrow 30.

As shown in FIG. 2, the soldering surface 16 is flatly attached on the bottom 14 of the printed circuit board 12, whereby a soldering paste is preferably applied flat onto the soldering surface 16 and top of bottom side 14 of the printed circuit board 12, so that a type of soldering pad is crated. However, it is also possible to provide the soldering surface 16, contact surface 18 and spring contact element 10 on the top 18 of the printed circuit board 12. Furthermore, it is also possible to provide one or more spring contact elements 10 on the bottom 14 and top 18 of the printed circuit board 12.

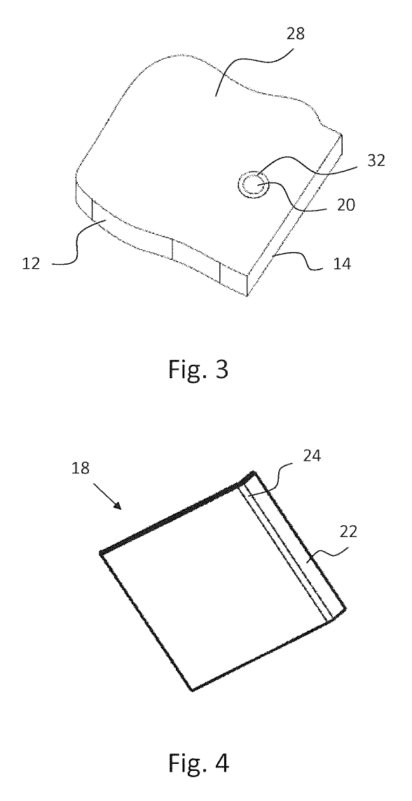

FIG. 3 shows the printed circuit board 12 in form of a top view of the top 28 of the printed circuit board 12, whereby it can hereby be recognized, that the design shown here has a printed circuit board 12 with a through-flow bore 20. The through-flow bore 20 can be designed as a ventilation bore or through-flow contacting, through which heat that develops during soldering and/or air from the soldering surface 16 can escape to prevent the developing of air bubbles and/or cavities between the soldering surface 16 and the contact surface 18 that is arranged on the soldering surface 16. The design shown here has a through-flow bore 20 that is designed as through contacting, where a metallized ring 32 on the inner surface of the through-flow bore 20 is designed, which enables anchoring the soldering agent applied to soldering surface 16. The through-flow bore 20 is also denoted in FIG. 2, whereby the through-flow bore 20 in FIG. 2 is coated with the soldering agent applied to the soldering surface 16.

FIG. 4 shows the level contact surface 18, whereby the contact surface 18 is a sheet metal element, which is mainly shaped level, whereby the edge area 22 of the contact surface 18 has a chamber-bevel 24. The chamber-bevel 24 is hereby designed in form of an angular offset of the contact surface 18 designed as a sheet metal element on the edge area 22. The chamber-bevel 24 is hereby shaped in an able to the contact surface 18 designed as a sheet metal element on the edge 22. The chamber-bevel is thereby shaped so that the chamber-bevel 24, as shown in FIG. 1, touches a side area 26 of the printed circuit board 12 when arranged on the printed circuit board 12 and protects the printed circuit board 12 in this area of the side area 26 of the printed circuit board 12 and, at the same time, serves as a guide agent when securing the spring contact element 10 on the printed circuit board 12.

### REFERENCE LIST

Spring contact element 10

Printed circuit board 12

Bottom 14

Soldering surface 16

Contact surface 18

Through-flow bore 20

Edge 22

Chamber-bevel 24

Side 26

Top 28

Slide-on direction 30

Metallized ring 32

What is claimed is:

1. Electrical contact arrangement of a spring contact element on a printed circuit board with a soldering surface that is arranged on a surface of the printed circuit board and a level contact surface that is arranged on the soldering surface, whereby the spring contact element must be arranged on the contact surface.

2. Electrical contact arrangement according to claim 1, marked in that the level contact surface is a sheet metal element.

3. Electrical contact arrangement according to claim 1, marked in that the spring contact element can be slid onto the level contact surface parallel to the longitudinal surface of the printed circuit board.

4. Electrical contact arrangement according to claim 1, marked in that a soldering paste is applied on the soldering surface to create a mat-shaped soldering paste surface on the surface on the printed circuit board.

5. Electrical contact arrangement according to claim 1, marked in that the printed circuit board has a through-flow bore in the area of the soldering surface, whereby the through-flow bore is designed as a ventilation bore or whereby the through-flow bore is provided to create through-contacting.

6. Electrical contact arrangement according to claim 1, marked in that the contact surface must have a bevel and/or chamber-bevel on at least one of its edges.
